(19) United States
(12) Patent Application Publication
(10) Pub. No.: US 2012/0084105 A1
(43) Pub. Date: Apr. 5, 2012

(54) METHOD FOR SELECTING A ROUND TRIP TRANSPORT SERVICE IN ONE CLICK

(75) Inventor: Winfried Boeing, Cologny (CH)

(73) Assignee: BOEING NETFLYER INFORMATION SERVICES, Cologny (CH)

(21) Appl. No.: 13/376,076

(22) PCT Filed: Jun. 1, 2010
(86) PCT No.: PCT/IB10/52437

§ 371 Date: Dec. 2, 2011

(30) Foreign Application Priority Data
Jun. 2, 2009 (CH) 00840/09

(51) Int. Cl. G06Q 50/14

(52) U.S. Cl. 705/6

(57) ABSTRACT

The present invention concerns a method for selecting in one click a round trip transport service among a plurality of transport services between a departure place and a destination for a preferred departure date and a preferred return date, said plurality of transport services covering direct and/or multi-stop journeys at various prices, said method comprising the steps of:—displaying on a first axis a range of dates covering at least the preferred departure and return dates;—displaying on a second axis a range covering the various prices of said plurality of transport services;—selecting transport services corresponding to said departure place, said destination and at least said preferred departure and return dates;—for each of said selected transport services, placing the service at a level on the second axis corresponding to the price associated with this service;—on the first axis, placing at least one icon corresponding to the departure date and at least one icon corresponding to the return date of said transport service, these icons being linked by an information bar;—selecting one of the displayed transport service by clicking on said information bar.

### TECHNICAL FIELD

The present invention concerns a method for selecting a round trip transport service among a plurality of transport services in one click. More specifically, the method of the invention enables the selection of a transport service such as a flight in one click thanks to a comprehensive fare display for transport services such as round trip travel routes. The invention relates to a new type of air fare search result selection and display, with the option of flexibility in travel dates and use of different travel providers or different departure places.

### BACKGROUND ART

In the case of air travel, about 80% of trips are round trips, with the passenger returning to his originating location. Modern search engines and web sites display the results of the search in various formats. If the search is related to the price of air travel, the prices are usually displayed in tabular format, either as single line/multiple lines or in a matrix.

The search string has to include the place of departure, the destination location, and two dates: the departure date and the return date.

As the complexity of a round trip involves two decision points on which day/time the passenger wants to leave, the search engine resolves the query with a list of possible solutions, indicating the price, travel provider and travel time for each solution.

Once the result of the search is displayed, in table format or in any other format, the user has to click on a travel service to obtain additional information concerning the flight. Only when the additional information for several flights is compared by the user, can he/she select one of the proposed flights.

The table grid view has many price points. It lacks the clarity that is needed to find the best fares “at a glance”. One can imagine using colors to highlight the best fares or similar graphical aids, but the sorting of information through simple inspection is almost impossible for the human brain. Adding additional attributes such as departure time makes the table illegible. Typically, a search for best fares involves changing dates of travel, travel providers and checking all additional options, such as number of stops and travel time. It often results in lengthy and time consuming research since many fare points (tables) have to be compared. If, for example, the traveler has the option of traveling a month later, the new search result would have to be displayed in a separate table. To compare both options, the traveler has to compare and analyze two results (or two tables).

Some prior art display systems provide a classification of the fares which enable a user to easily find the best fare. However, in all of the existing systems, when the different transport services are grouped according to the fares, important data is missing. In particular, in some systems, the number of stops is not provided. In other systems, the date is not displayed. Thus, it is not possible to compare different journeys for one or two days around the preferred date.

### DISCLOSURE OF INVENTION

The object of the present invention is to provide a method for searching and presenting a round trip fare display with different departure/return dates in a legible format for the human brain, sorting the best fare option to the worst fare option in a sequential order. Moreover, according to the present invention, all the useful pieces of information are displayed at the same time. Therefore, the user can select in one click, the most adapted transport service.

The aim of the invention is achieved thanks to a method for selecting in one click a round trip transport service among a plurality of transport services between a departure place and a destination for a preferred departure date and a preferred return date, said plurality of transport services covering direct and/or multi-stop journeys at various prices, said method comprising the steps of:
displaying on a first axis a range of dates covering at least the preferred departure and return dates;
displaying on a second axis a range covering the various prices of said plurality of transport services;
selecting transport services corresponding to said departure place, said destination and at least said preferred departure and return dates;
for each of said selected transport services, placing the service at a level on the second axis corresponding to the price associated with this service;
on the first axis, placing at least one icon corresponding to the departure date and at least one icon corresponding to the return date of said transport service, these icons being linked by an information bar;
selecting one of the displayed transport service by clicking on said information bar.

### BRIEF DESCRIPTION OF DRAWINGS

The present invention and its advantages will be better understood with reference to the enclosed drawings and to the detailed description of a particular embodiment, wherein:

FIGS. 1 to 5 show prior art displays;

FIG. 6 illustrates the displayed information used by the method of the invention according to a first embodiment;

FIG. 7 illustrates the displayed information used by the method of the invention according to a second embodiment;

FIG. 8 illustrates the displayed information used by the method of the invention according to a third embodiment; and

FIG. 9 is a block diagram representing the method of the invention.

### BEST MODE FOR CARRYING OUT THE INVENTION

Usually, a user planning a trip gives at least the following information: the departure date; the return date, the departure location and the destination. After having introduced this information, the user expects to receive the following data: the departure time, the arrival time, possibly the flight duration, the number of stops as well as the fare. Most often, the sorting criteria is the fare.

FIGS. 1 to 5 show different results obtained by prior art methods. In FIG. 1, each result is displayed in a text block format giving all the relevant data. However, it is almost impossible to quickly compare several results in order to find the best matching transport service.

In FIG. 2, the results are sorted by convenience (number of stops) and not according to the fares. However, a “manual” sorting can be done quite easily. The drawback of the method illustrated by FIG. 2 is that for each flight, important data is missing such as the departure and return dates/times.

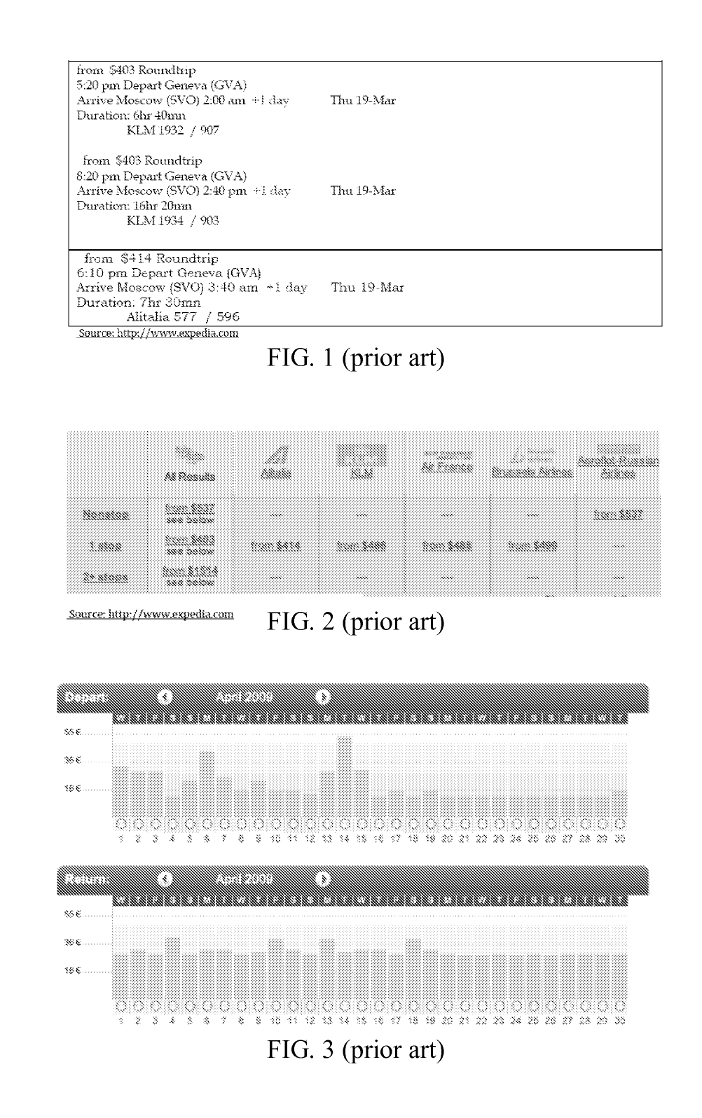

In FIG. 3, the departure times, the airline and the number of stops is not displayed. Thus, it is not possible to select the best matching flight in one click.

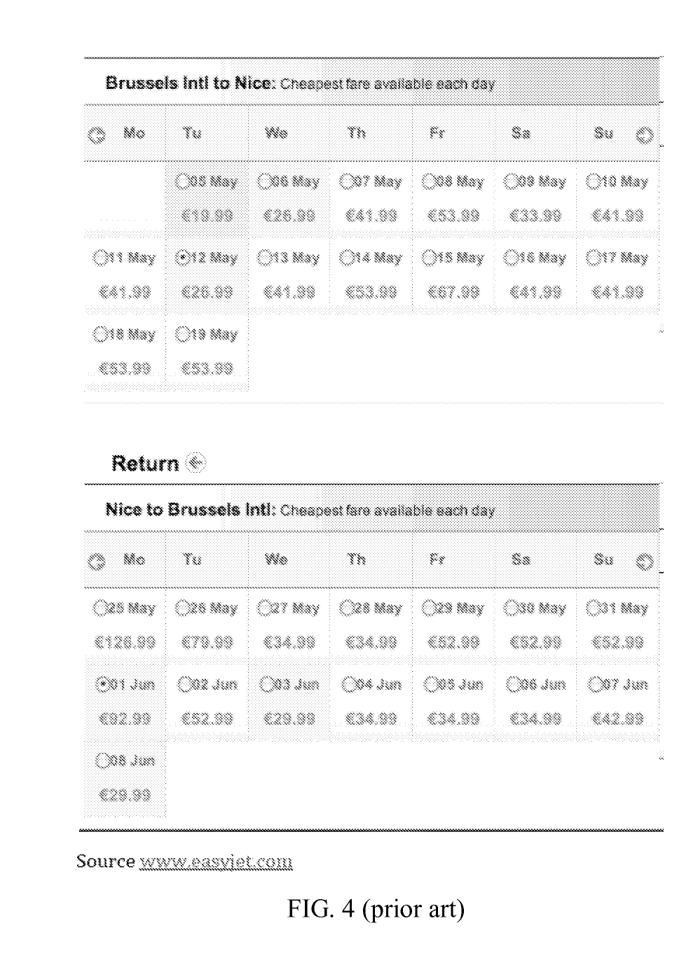

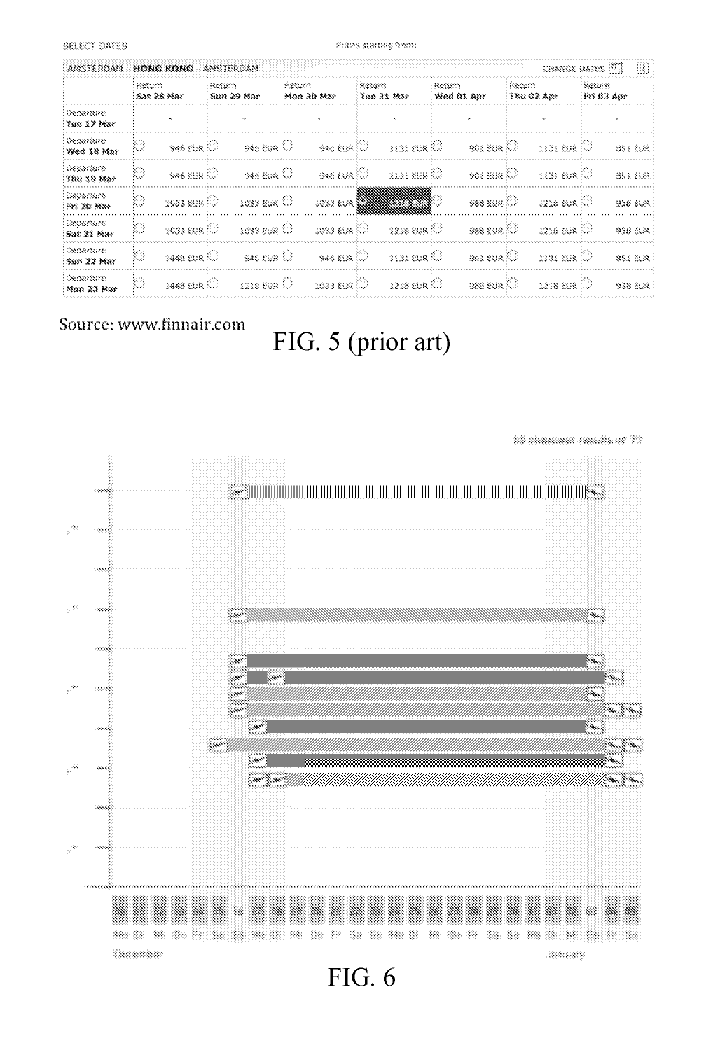

In FIG. 4, the departure time and the number of stops are not displayed and the flights are not sorted by fare. Selecting one flight requires a “manual” sorting as well as several clicks to access additional information. The same applies to FIG. 5.

The method of the invention enables a user to select in one click, or touch, a best matching transport service among a plurality of available transport services. In order to enable the user to select such a service in one click, all the relevant data is displayed in a specific format. Thus, the user can choose the most relevant service.

The method of the invention enables the retrieval of flights from a database and to display the flights corresponding to the search criteria in such a way as to immediately identify the cheapest flight, while providing other pertinent or relevant information to the user.

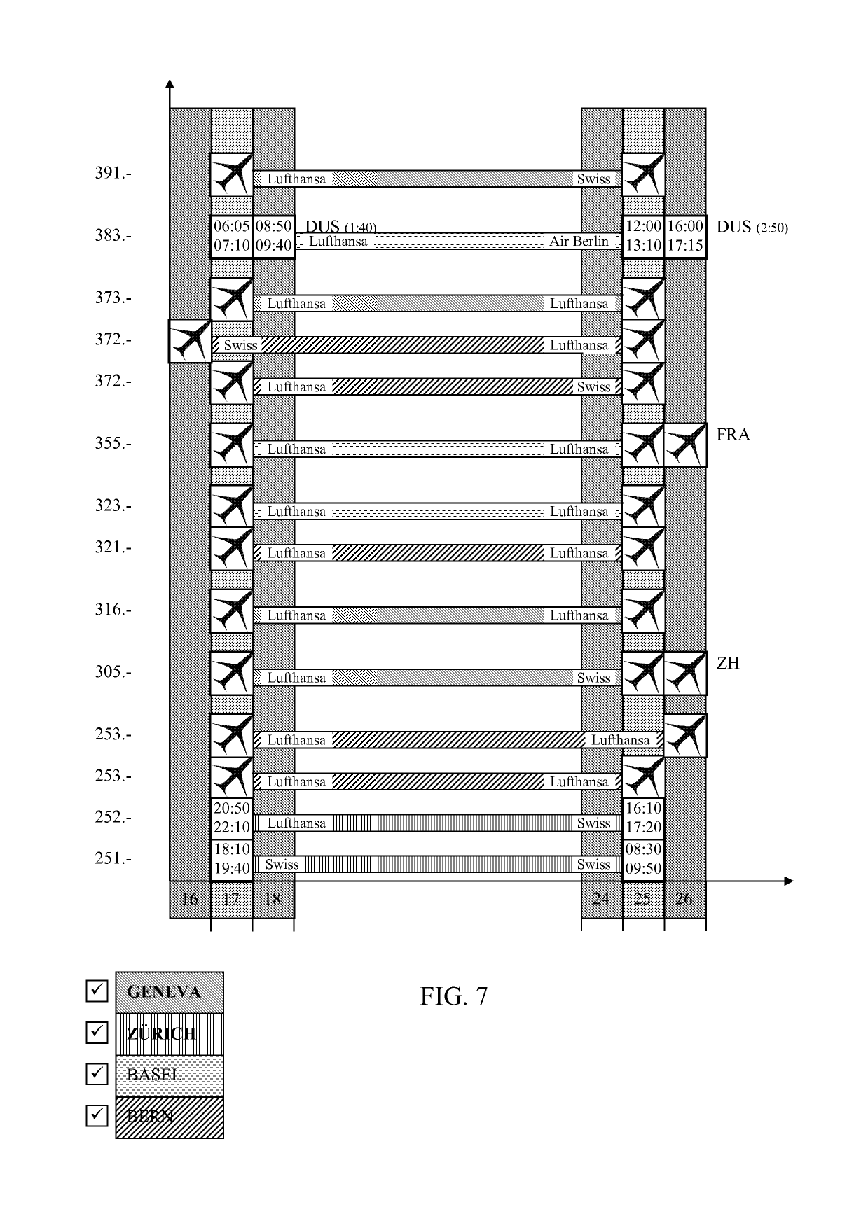

As illustrated in FIGS. 6, 7 and 8, the relevant transport services are displayed on an X-Y diagram. On the Y-axis (vertical), the price is displayed, indicating the fare level. On the X axis (horizontal), at least the departure date and the return date are shown. According to a preferred embodiment, a given margin is shown around the preferred departure and return dates, for example ±two days in FIG. 6 and ±one day in FIG. 7. The margin before the preferred date could be different from the margin after the preferred date.

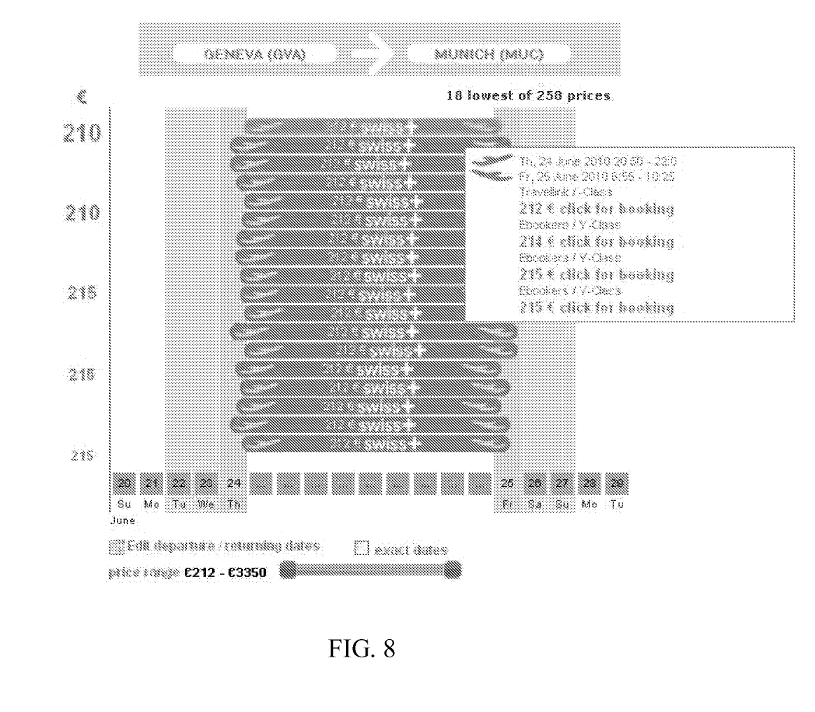

The displayed transport services are sorted from the cheapest to the most expensive, in such a way that the result of the search is visible “at a glance” and does not require skills or conversion. This sorting can be done from bottom to top as in FIG. 7 or from top to bottom as in FIG. 8.

The departure date of each displayed transport service is represented by an icon placed in a column corresponding to the departure date, so that it is immediately apparent whether the departure date is the preferred date or another date within the authorized margin. The same applies for the return date.

A number of icons corresponding to the number of flight segments for going from the departure location to the destination are also displayed. For a direct flight, one icon would be displayed in the column corresponding to the departure date. A one-stop flight or two flight segments would be represented by two icons. This applies for the departure flight as well as for the return flight. The icons representing the departure flight and the return flight of a transport service are linked by an information bar. One click on this information bar enables the selection of the service concerned.

In FIG. 6, colors or other visual indication of the information bar are used to identify the travel provider (airline). Further attributes like travel time or class of service can easily be added to the bar. Furthermore, additional data could be added on the right side of each line. An example of such additional data could be the “flexibility” of the ticket. If the ticket can be easily changed, with or without additional payment, in order to enable the user to take the following flight for example, the possibility of changing the ticket as well as the cost for such a change could be added to the side of the information bar. The same flight could therefore appear twice in the diagram, once at a given price with an indication that the ticket can not be changed and once at another price with the indication that the ticket can be changed with possibly a surcharge.

According to an alternative embodiment illustrated by FIG. 7, the color or other visual indication of the information bar could be used to display important information. As an example, the displayed flights could relate to not only one departure airport, but also the closest airport from the user's departure place. For example, the user could indicate the place where he/she lives instead of a departure airport. According to the method of the invention, the display could indicate the flight fares from several airports around his place of residence. Each airport could correspond to a specific color.

As an example, FIG. 7 displays the fares for flights having the following specifications: preferred departure date=17; preferred return date=25; date margin on the outward and return flight ±1 day; selected airports=Geneva, Zurich, Basel, Bern.

According to this example, the visual indication of the information bar is related to the departure airport. The additional information can also be added as shown on FIG. 7. For example, the departure and arrival time for each flight can be displayed in the information bar as well as the airline. Different icons can also be used for different classes of service such as economy or business class.

FIG. 8 illustrates a third embodiment for displaying the data obtained according to the method of the present invention. In this drawing, the flights are represented, as in FIGS. 6 and 7, by an icon placed in a column corresponding to the departure date and by an icon placed in a column corresponding to the return date. The icons are linked by a bar. In this specific embodiment, the beginning of the bar corresponds to the departure time. This means that a flight departing in the morning will be linked to a bar which begins at the left hand side of the column corresponding to the departure day. A flight departing in the evening will be linked to a bar which begins at the right hand side of the column corresponding to the departure day.

The same applies for the arrival time. Thus, if the user must depart in the morning and return in the evening, suitable flights can be readily identified.

According to another feature of this embodiment, a first type of operations such as placing a computer mouse or any other pointing device on a specific bar enables the display of additional data. This data can be the exact departure and arrival time, a flight category (economy class, business class, . . . ), a flight provider, the duration of the flight, a link enabling the specific flight to be booked or any other data that can be found relevant. A second type of operation such as clicking on the bar gives access to a link for booking the flight or may even enable to book the flight directly.

Still another feature of this embodiment concerns the display of a price range. Usually, the number of flights corresponding to the search criteria (preferred departure date±range; preferred return date±range; destination, . . . ) is higher than what can be displayed without affecting readability. In order to solve this problem, a range bar corresponding to the price range between the lowest fare and the highest fare is displayed. The left extremity of the bar corresponds to the lowest fare and the right extremity corresponds to the highest fare. Two cursors are also displayed on that range bar. If these cursors are in a default position, i.e. the cursors are in the extreme positions, a given number of flights with the lowest rates are displayed. The lowest and the highest fares of the range defined by the cursors are displayed in text format. If one the cursors is moved, for example if the left cursor is moved towards the right, the lowest fare that is displayed is increased. This can also be used to scroll among the different flights retrieved and to display flights other than the cheapest ones.

Similarly, if the right cursor is moved towards the left, the upper limit of the interval is lowered. Only the flights corresponding to fares comprised in the price range are displayed.

As can be seen from FIGS. 6, 7 and 8, the relevant data is displayed at the same time. This enables the user to select the flight corresponding to his requirements in one click.

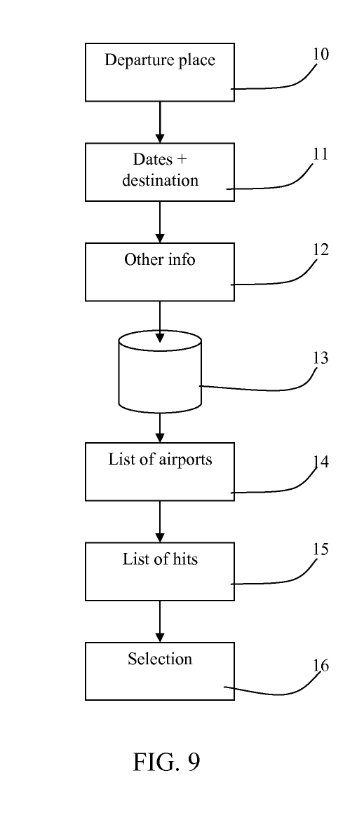

FIG. 9 shows the method of the invention according to the embodiment of FIG. 7 in the form of a block diagram. In a first step, with reference 10, the user indicates his departure point. The user must also indicate his preferred departure date, the preferred return date and the destination in a step 11. Depending on the embodiment, the flexibility of traveling at different dates is displayed by default. This flexibility can either be before, after or around the preferred dates and the range can be 1, 2 or 3 days for example. According to a particular embodiment, this flexibility could be inserted and controlled by the user.

Additional information may be required as input from the user such as class of service, the number and age of passengers, special discounts, refund requirements, insurance, etc. This is introduced by the user in step 12.

A request is sent in step 13 to a database for retrieving a list of airports which are at “a reasonable distance” from the place where the user resides or departs and which proposes flights to the specified destination. These flights could be direct flights or multi-stop flights. The request also contains all the information entered by the user.

The result is displayed as in FIG. 7 or 8. The system can optionally display, in a step 14, the list of proposed airports. The user can accept or modify the proposed list. A list of hits is displayed to the user in a step 15. In case of multi-stop flights, a number of icons are displayed corresponding to the number of flight segments. The name of the stop-over can also be displayed, with optionally, the waiting time between two connecting flights.

The last step of the method of the invention is selecting one transport service among the list of hits.

The present invention is disclosed in the given examples with reference to transport services by air. However, it is understood that other kinds of transport services, for example by train, bus or boat could also use the described method of the invention managing the complexity of return journeys.

In the illustrated examples, the travel services are sorted by price only. It is however also possible to use as first criteria, another one such as the number of stops or the departure airports. Thus, all the direct flights would be grouped. The flights of each group can than be sorted according to the price. Similarly, all the flights departing from a given airport could be grouped and separated from the multi-segment flights. The way the transport services are displayed (i.e. by price, grouped according to the number of stops, by airport, . . . ) could be chosen by the user.

It is also possible to limit the flights displayed according to specific criteria entered by the user. Such criteria can be for example that the flight must land before a given hour of the day or that the return flight must take off after a given hour.

1. A method for selecting in one click a round trip transport service from among a plurality of transport services between a departure place and a destination for a preferred departure date and a preferred return date, said plurality of transport services covering direct and/or multi-stop journeys at various prices, said method comprising the steps of :
displaying on a first axis a range of dates covering at least the preferred departure and return dates;
displaying on a second axis a range covering the various prices of said plurality of transport services;
selecting transport services corresponding to said departure place, said destination and at least said preferred departure and return dates;
for each of said selected transport services, placing the service at a level on the second axis corresponding to the price associated with this service;
on the first axis, placing a first icon corresponding to the departure date and a second icon corresponding to the return date of said transport service, the first and second icons being linked by an information bar;
receiving a selection of one of the displayed transport service, the selection being, accomplished by clicking on said information bar.

2. The method according to claim 1, wherein the range of dates covers extended departure dates comprising said preferred departure date, and extended return dates comprising said preferred return date.

3. The method according to claim 1, wherein said information bar comprises a visual indication of a number of stops, said visual indication comprising displaying one icon per travel segment between the departure place and the destination.

4. The method according to claim 1, wherein at least one additional indication is displayed for each of the selected transport services.

5. The method according to claim 4, wherein said additional indication is selected from among the group consisting of a travel company, the name of a stop over in case of multi-segment flight, a departure airport, a departure hour, an arrival hour, a flight time, a waiting time in case of multi-segment flights, a travel class and conditions related to the changing of a travel ticket.

6. The method according to claim 1, wherein said selection of transport services comprises a step of selecting airports or places within a given distance from the departure place.

7. The method according to claim 1, wherein the information bar is placed on the departure date in a position which reflects an actual departure time and wherein said information bar is placed on the return date in a position which reflects an actual departure time of the return flight.

8. The method according to claim 1, further comprising a step of defining a number of days before and after the preferred departure date to define an extended departure date, and a step of defining a number of days before and after the preferred return date to define an extended return date.

9. The method according to claim 1, wherein a first type of operation on one flight displays additional information concerning said flight and a second type of operation on a flight selects said flight for booking it.

10. The method according to claim 1, further comprising a step of selecting a lowest fare limit defining a lowest fare of the flights displayed and a highest fare limit defining a highest fare of the flights displayed.

11. The method according to claim 1, further comprising a step of defining restriction criteria, the flights displayed corresponding to the flights having fulfilled the restriction criteria.

12. The method according to claim 11, wherein the restriction criteria are chosen from among the group consisting of a departure time, an arrival time, a return time a return arrival time, a duration and a number of stops.
